(19) United States
(12) Patent Application Publication
(10) Pub. No.: US 2018/0249723 A1
(43) Pub. Date: Sep. 6, 2018

(54) FOOD AGING DEVICE, MANAGEMENT SYSTEM, AND MANAGEMENT METHOD THEREOF

(71) Applicant: CHI-SHEN HSU, TAICHUNG CITY (TW)

(72) Inventor: CHI-SHEN HSU, TAICHUNG CITY (TW)

(21) Appl. No.: 15/906,251

(22) Filed: Feb. 27, 2018

(30) Foreign Application Priority Data
Mar. 3, 2017 (TW) 106106976
Nov. 10, 2017 (TW) 106138966

(51) Int. Cl. A23B 4/03; A23B 4/16; A23L 3/3427; A23L 3/00; G05B 15/02

(52) U.S. Cl. CPC A23B 4/031; A23B 4/16; A23V 2002/00; A23L 3/001; G05B 15/02; A23L 3/3427

(57) ABSTRACT

Disclosed are a food aging device, a management system and a management method thereof. The device helps improve flavor of aged food and is useful and convenient. Further, a user may use an electronic device to detect and read a product identification label arranged outside the device to conduct management of aging of the food so that the user is notified to remove and taste the food at the best taste date.

### FIELD OF THE INVENTION

The present invention relates to a device, a management system, and a management method thereof, and in particular to a food aging device, a management system, and a management method thereof.

### BACKGROUND OF THE INVENTION

Food aging is a continuous process that increases tenderness, flavor, and juicy of food and is generally classified as wet aging and dry aging.

Wet aging is conducted through vacuum packing of food, such as beef, and natural enzymes contained in the food makes the food aged in the vacuum bag to improve the flavor of the food. Dry aging is a process in which food is not packaged and is air-dried in a low temperature, where the food is placed in an aging rook kept in a constant temperature and constant humidity to allow the natural enzymes contained in the food and also outside microorganisms to improve the flavor of the food. Also, water gets evaporating from the food organization to concentrate the flavor of the food itself.

Generally speaking, the wet aging that is conducted with a vacuum bag is more convenient than the dry aging and thus, wet aging is more commonly used. However, for people loving delicious food and more concerned about the flavor of the food, food of wet aging is no match of food of dry aging, for the food flavor of the dry-aged food is more concentrated and more saturated than that of the wet-aged food. However, placing food in an aging room of controlled temperature and humidity for dry aging is not convenient for general consumers. Thus, it is an emerging issue for the food industry to allow food, after aged, to possess the flavor that is traditionally achieved with dry aging.

In addition, aging requires time of waiting and the time of taste is a key factor that affects the flavor of the food. However, time management is currently conducted with manual control and may easily pass the best time of taste due to inadvertence. In addition, aging environment and aging time are different from food to food and planning an aging project is generally an art of experience that cannot be accurately handled by generally consumers.

In view of the above, the present inventor, based on years' research and thinking, creates a device, a system, and a method, such that in addition to a device that makes food aging easy and improves food flavor, may effectively manage and control of time to allow the generally consumers to timely handle the aging state of food and be notified at the best taste time of the food. Further, the present invention also provides suggestions of pre-established aging processes for different kinds of food that the generally consumers may find easy to use.

### SUMMARY OF THE INVENTION

The first objective of the present invention is to provide a device that is useful and convenient to allow food, after aged, with the flavor that is traditionally obtained with dry aging.

The second objective of the present invention is to provide systematic food aging management, which allows a user to timely handle an aging state of food and to be notified at the time of best taste of food.

The third objective of the present invention is to include, in a system, proposed aging processes provided for food of different kinds that allow people who are not skilled in food aging to select and use.

The fourth objective of the present invention is to provide food traceability data to the user, so that the user may realize data concerning the source, shipping location, and shipping date of food.

To achieve the above objectives, the present invention discloses a food aging device, which comprises a main body, which comprises a food receiving chamber in which food is positionable; and at least one gas valve, which is mounted to the main body, wherein, through the at least one gas valve, gas inside the food receiving chamber is evacuateable or a filling gas is chargeable into the food receiving chamber.

The present invention also discloses a food aging management system, which comprises a transmission module, a processing module, and an aging management module. The transmission module detects, by means of an electronic device, a product identification label of a food aging device in order to acquire a product signal. The processing module is connected to the transmission module to receive the product signal and to transmit an execution message. The aging management module is connected to the processing module in order to receive the execution message for carrying out aging management. The aging management module comprises a database, a setting unit, a management and control unit, and a notification unit. The database comprises aging data. The setting unit provides, according to the aging data, at least one option of aging process so that, after a selection message is received from a user through a setting interface, a setting message is transmitted. The management and control unit receives the setting message and manages and controls an aging time period of food positioned in the food aging device according to contents of the aging process option made by the user and transmits an aging message. The notification unit receives the aging message and transmits a notification message through the transmission module to be displayed on the electronic device.

Further, the present invention further discloses a food aging management method, which comprises: detecting a product identification label of a food aging device with an electronic device of a user to acquire a product signal; providing at least one option of aging process corresponding to the product signal; receiving a message of selection of the option of aging process made by the user; generating an aging time period; managing and controlling the aging time period; and transmitting a message of notification.

### BRIEF DESCRIPTION OF THE DRAWINGS

The present invention will be apparent to those skilled in the art by reading the following description of preferred embodiments thereof with reference to the drawings, in which:

FIG. 1 is a schematic view showing a first example of a food aging device according to the present invention;

FIG. 2 is a schematic view showing a second example of the food aging device according to the present invention;

FIG. 3A is a schematic view showing a first example of a gas valve of the food aging device according the present invention;

FIG. 3B is a schematic view showing a second example of a gas valve of the food aging device according the present invention;

FIG. 4 is a schematic view showing a third example of the food aging device according to the present invention;

FIG. 5 is a schematic view showing a fourth example of the food aging device according to the present invention;

FIG. 6 is a schematic view showing a fifth example of the food aging device according to the present invention;

FIG. 7A is a schematic view showing a sixth example of the food aging device according to the present invention;

FIG. 7B is a schematic view showing a seventh example of the food aging device according to the present invention;

FIG. 8 is a view illustrating an example of architecture of a food aging management system according to the present invention;

FIG. 9 is a view illustrating another example of architecture of the food aging management system according to the present invention;

FIG. 10 is a schematic view illustrating a state of use of the food aging management system according to the present invention;

FIG. 11 is a flow chart illustrating a food aging management method according to the present invention; and

FIG. 12 is a flow chart illustrating a food aging management method according to another example of the present invention.

### DETAILED DESCRIPTION OF THE PREFERRED EMBODIMENTS

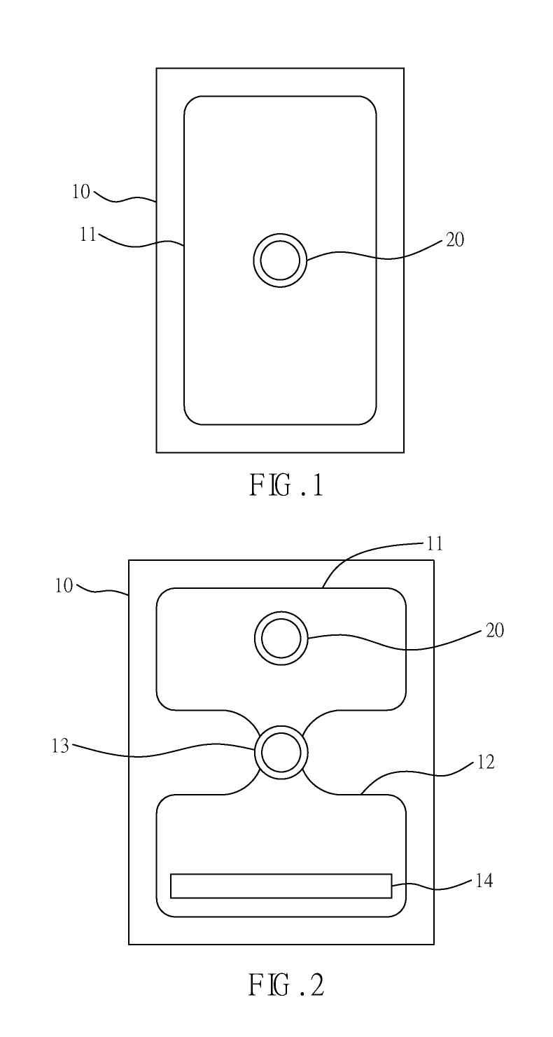

Firstly, referring to FIG. 1, a schematic view of a first example of a food aging device according to the present invention is shown. The present invention discloses a food aging device, which comprises: a main body 10, wherein the main body 10 comprises a food receiving chamber 11, which receives food, such as beef, pork, sausages, duck, and mutton, and at least one gas valve 20, which is mounted to the main body 10 to allow a food packaging machine (not shown) to withdraw, through the gas valve 20, gas contained in the food receiving chamber 11 to a level approaching or being vacuum, or alternatively, to be filled through an external gas container (not show), such as a gas canister, with a filling gas. The filling gas can be one single kind of gas, or a mixture gas formed according to a predetermined ratio, and the filling gas can be carbon dioxide, inert gases, such as nitrogen, or a mixture gas that includes a predetermined ratio of oxygen mixed therein.

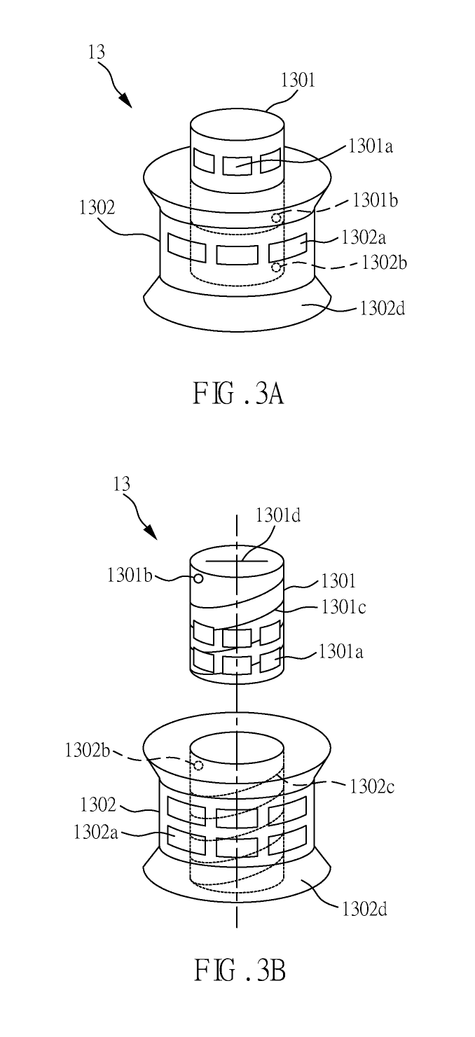

Next, referring to FIG. 2, a schematic view of a second example of the food aging device according to the present invention is shown. In the instant embodiment, the main body 10 further comprises a function chamber 12. The function chamber 12 is connected with, or isolated from, the food receiving chamber 11 by means of a valve 13. When the valve 13 is closed, the valve 13 isolates the food receiving chamber 11 and the function chamber 12 from each other, meaning the food receiving chamber 11 and the function chamber 12 are not in communication with each other. When the valve 13 is open, the valve 13 is in a condition of being in communication with the food receiving chamber 11 and the function chamber 12, meaning the food receiving chamber 11 and the function chamber 12 are in communication with each other. Fluid contained in the food receiving chamber 11 is thus allowed to flow into the function chamber 12, and fluid contained in the function chamber 12 is allowed to flow into the food receiving chamber 11. The fluid comprises a gas or a liquid.

At least one of the main body 10, the gas valve 20, the food receiving chamber 11, the function chamber 12, and the valve 13 is made of food-grade plastics, and the food-grade plastics may comprise polypropylene (PP), polystyrene (PS), polyethylene terephthalate (PET), or polyethylene (PE).

Further, the food aging device according to the present invention may further comprise at least one desiccant 14, which is arranged inside the function chamber 12. When the valve 13 is open, the food receiving chamber 11 and the function chamber 12 are in communication with each other and the desiccant 14 may absorb moisture vaporizing and escaping from the food placed in the food receiving chamber 11 during an aging process. With the desiccant 14 absorbing moisture, pneumatic pressure and moisture do not balance between the food receiving chamber 11 and the function chamber 12, so that moisture vaporizing and escaping from the food placed in the food receiving chamber 11 during the aging process is caused to flow faster into the function chamber 12, allowing for continuous vaporization of water contained in the food organization to thereby age the food and make the flavor of the food close to that of food that is aged with a traditional dry aging process. The desiccant 14 is a food-grade desiccant and has a packaging material that is food-grade plastics.

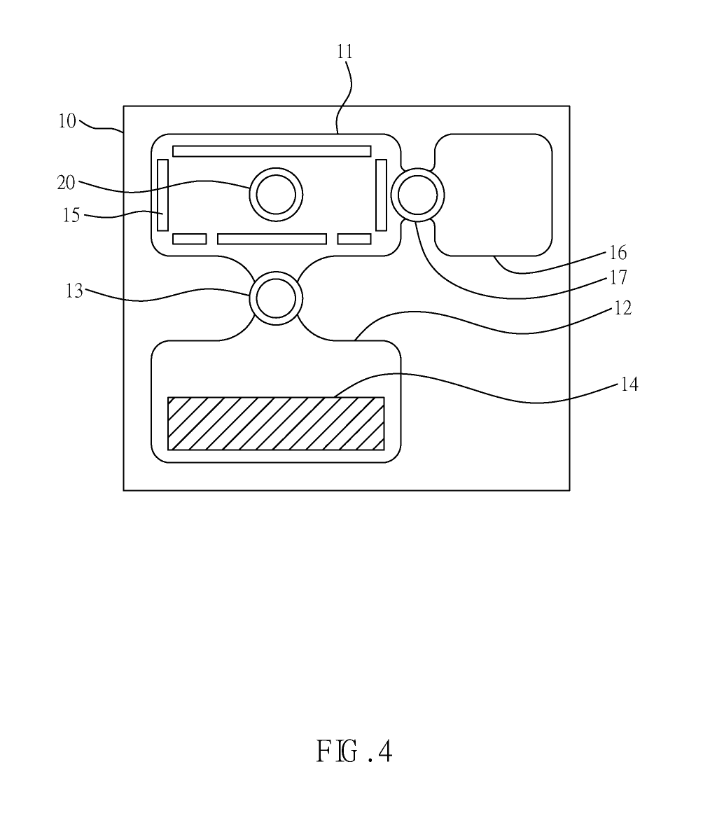

Referring to FIG. 3A, a schematic view showing a first example of the gas valve of the food aging device according the present invention is provided. In the instant embodiment, the valve 13 comprises an inner valve cylinder 1301 and an outer valve barrel 1302. The inner valve cylinder 1301 is arranged inside the outer valve barrel 1302. The inner valve cylinder 1301 comprises a first air hole 1301a, and the outer valve barrel 1302 comprises a second air hole 1302a. The outer valve barrel 1302 has an external wall having an end connected to the food receiving chamber 11, and an opposite end of the external wall of the outer valve barrel 1302 is connected to the function chamber 12. The outer valve barrel 1302 has a solid bottom 1302d.

The valve 13 has an initial condition that is a closed state, wherein the first air hole 1301a and the second air hole 1302a are not in alignment with each other so that the food receiving chamber 11 and the function chamber 12 do not communicate with each other and thus, the food receiving chamber 11 and the function chamber 12 are isolated from each other. When a user press down the valve 13, the inner valve cylinder 1301 is moved with respect to the outer valve barrel 1302 to set the valve 13 in an open state, with the first air hole 1301a aligned with the second air hole 1302a to have the food receiving chamber 11 and the function chamber 12 communicating with each other, allowing fluid contained in the food receiving chamber 11 and fluid contained the function chamber 12 to flow into and mix with each other thereby balancing the internal pneumatic pressure of the food receiving chamber 11 and the internal pneumatic pressure of the function chamber 12, meaning pressures balance with each other, and moisture vaporizing and escaping from the food placed in the food receiving chamber 11 during an aging process may flow into the function chamber 12 to keep water contained in the food persistently vaporizing, allowing the food to continuously age and making the flavor of the food more concentrated and the flavor of the food closer to that of food that is aged with a traditional dry aging process.

In addition, the inner valve cylinder 1301 has an external wall that is formed with a bump 1301b. The outer valve barrel 1302 has an internal wall that is formed with a cavity 1302b that is engageable with the bump 1301b. When the valve 13 is open, meaning the user presses down the valve 13 to have the first air hole 1301a aligned with the second air hole 1302a, the cavity 1302b and the bump 1301b are set in engagement with each other, preventing the valve 13 from returning to the closed state. This makes it possible to avoid re-use of the food aging device by a user that might cause issues of food sanitary concern. In an embodiment of the present invention, the valve 13 is of a cylindrical shape; however, the shape of the valve 13 is not limited to a cylinder, and the valve 13 can be of any shape, provided the above-described function of the valve 13 can be achieved.

Referring to FIG. 3B, a schematic view showing a second example of a gas valve of the food aging device according the present invention is provided. Different from the first example, in the instant example, the inner valve cylinder 1301 has an external wall that is formed with an internal thread 1301c, and the outer valve barrel 1302 has an inner wall that is formed with an external thread 1302c that mates the internal thread 1301c. The inner valve cylinder 1301 is thus turnable in a direction of the threads with respect to the outer valve barrel 1302. When the user attempts to open the valve 13, the user may turn or rotate the inner valve cylinder 1301 to have the first air hole 1301a aligned with the second air hole 1302a. Under such a condition, the valve 13 is set in an open state and is in communication with the food receiving chamber 11 and the function chamber 12.

The valve 13 that comprises a threaded structure is capable of bearing an increased air pressure and also helps prevent, during a transportation process, the valve 13 from becoming an open state due to the valve 13 being squeezed, leading to undesired communication achieved too early between the food receiving chamber 11 and the function chamber 12.

In addition, the inner valve cylinder 1301 may have a top lid that is formed with a linear recessed grove 1301d, so that the user may use a tool, such as a coin, to rotate or turn the inner valve cylinder 1301 to set the valve 13 in the open state for communication between the food receiving chamber 11 and the function chamber 12. This prevents inadvertently rotating the inner valve cylinder 1301 to undesirably open the valve 13.

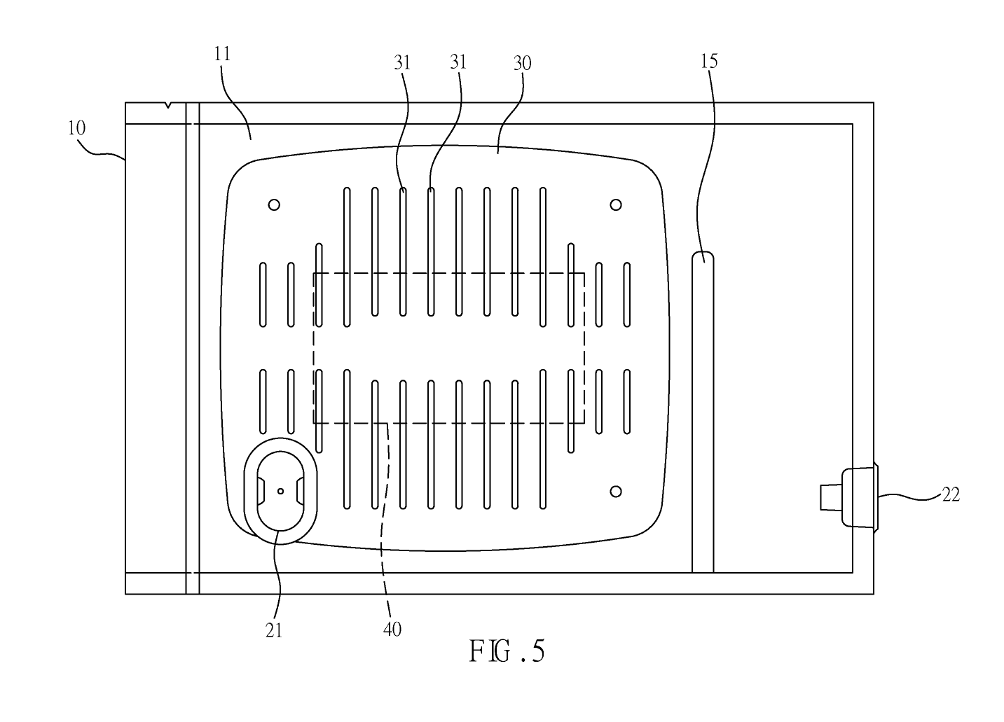

Referring to FIG. 4, a schematic view showing a third example of the food aging device according to the present invention is provided. The instant example uses the same reference numerals for the same parts as those of the previous examples and details of the same parts may refer to the description given above so that repeated description will be omitted here. The food aging device of the instant example further comprises at least one assistive chamber 16 and at least one assistive gas valve 17. The at least one assistive gas valve 17 is operable to provide communication between the food receiving chamber 11 and the at least one assistive chamber 16, or to isolate the food receiving chamber 11 and the at least one assistive chamber 16.

A structure, as well as description, of the assistive gas valve 17 are the same as those of the valve 13 of the previous example and repeated description will be omitted. The at least one assistive chamber 16 can be filled with a gas that is different from that filled in the food receiving chamber 11 or a gas that is filled in the function chamber 12. For example, in an embodiment of the present invention, when the valve 13 is in a closed state, the food receiving chamber 11 is filled with nitrogen; the function chamber 12 is in a vacuum condition; and the assistive chamber 16 is filled with carbon dioxide. After the food has been placed in the food receiving chamber 11 for 7 days, the valve 13 is open to allow the food to undergo further aging. At the tenth day, the assistive gas valve 17 is open to have the food receiving chamber 11 and the assistive chamber 16 communicate with each other, allowing carbon dioxide filled in the assistive chamber 16 to flow into the food receiving chamber 11 for adjusting development of microorganisms, making better flavor of the food.

It is appreciated that in an embodiment of the present invention, filling carbon dioxide in the assistive chamber 16 is provided as an example only and other gases may be used according to the preference of the user and the present invention is not limited to carbon dioxide. In other embodiments of the present invention, the assistive chamber 16 may be provided in multiplicity and the assistive gas valve 17 may also be provided I multiplicity. The assistive gas valves 17 are used to respectively provide communication between the food receiving chamber 11 and the assistive chambers 16, or to isolate the food receiving chamber 11 from the assistive chambers 16. According to the process and condition of desired food aging, the food receiving chamber 11, the function chamber 12, and each of the assistive chambers 16 may be filled with different gas. The assistive chamber (s) 16 and the assistive gas valve(s) 17 are made of food-grade plastics.

Further, the food aging device according to the present invention may further comprise at least one retention strip 15. The retention strip 15 constrains the food from moving inside the food receiving chamber 11 to prevent the food that is placed in the food receiving chamber 11 from contacting the valve 13 or the assistive gas valve 17 due to an irregular shape of the food that might cause blocking of an air passage of the valve 13 or the assistive gas valve 17 so as to prevent communication between the food receiving chamber 11 and the function chamber 12 or the assistive chamber 16 from being established after the valve 13 or the assistive gas valve 17 is open. The retention strip 15 can be formed through thermal pressing or can be made of food-grade plastics but is not limited thereto.

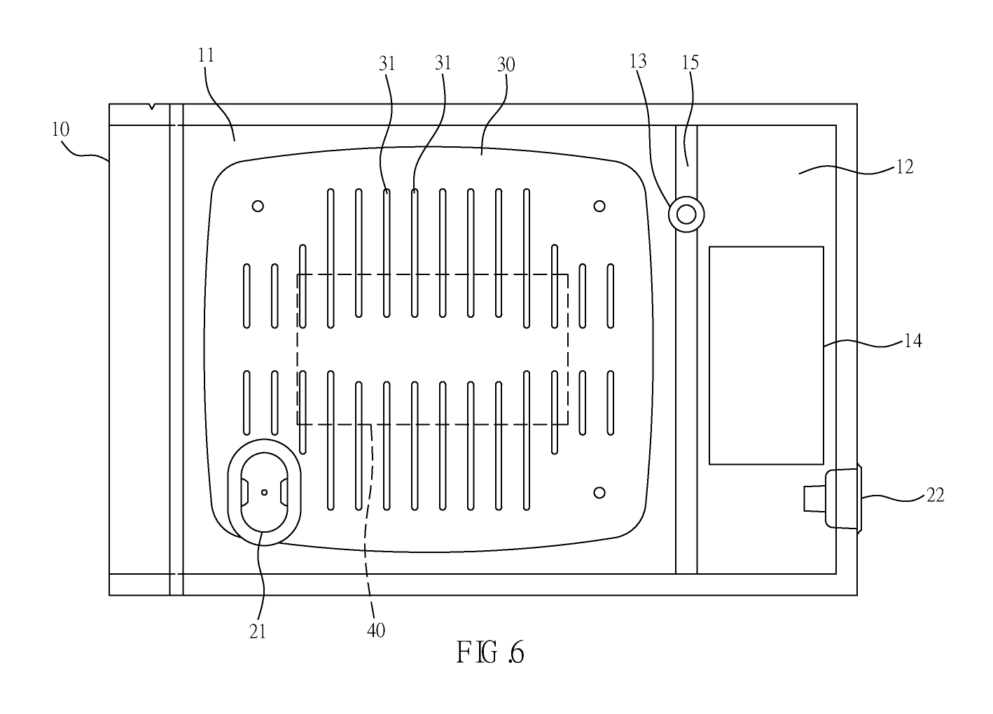

Referring to FIG. 5, a schematic view showing a fourth example of the food aging device according to the present invention is provided. In the instant embodiment, the main body 10 is made in the form of a pouch and at least two gas valves are provided and are respectively an outlet valve 21 and an inlet valve 22. The outlet valve 21 allows gas contained in the food receiving chamber 11 to be evacuated by the food packaging machine (not shown) and the inlet valve 22 allow a filling gas to be charged from an external gas container (not shown) into the interior of the food receiving chamber 11.

Further, the food aging device according to the present invention may further comprise a carrying tray 30, which is arranged inside the food receiving chamber 11. The carrying tray 30 has a surface that is provided with at least one projection 31. The projection 31 can be elongate straight form or a wavy form. When food is placed on the surface of the carrying tray 30 that comprises the projection 31, the projection 31 increases the chance of contact between the food and the filling gas. Further, the carrying tray 30 may have a size that is close to a size of the food receiving chamber 11 to prevent undesired movement of the carrying tray 30 in the food receiving chamber 11, or alternatively or additionally, the food receiving chamber 11 is provided therein with a retention strip 15 to retain the carrying tray 30 in position. The retention strip 15 can be formed through thermal pressing or can be made of food-grade plastics but is not limited thereto.

The food aging device according to the present invention may further comprise an absorbent 40, which is arranged on a top surface of a bottom surface of the carrying tray 30, provided liquid or moisture vaporizing and escaping from the food during an aging process can be absorbed. Also, the carrying tray 13 is formed with an opening (not shown) to allow liquid or moisture vaporizing and escaping from the food during an aging process to be quickly absorbed and removed by the absorbent 40.

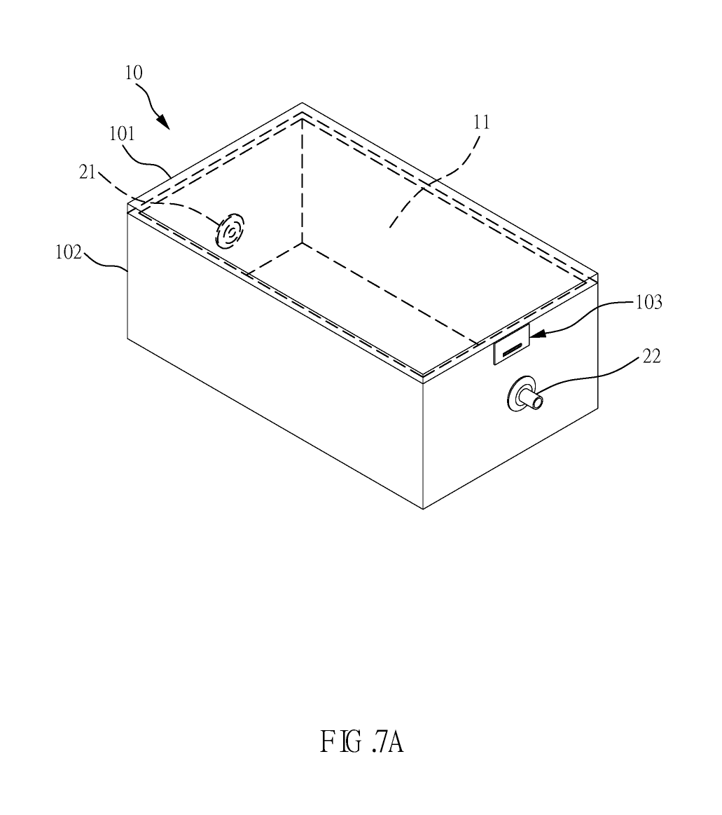

Referring to FIG. 6, a schematic view showing a fifth example of the food aging device according to the present invention is provided. In the instant example, the main body 10 comprises a function chamber 12. The food receiving chamber 11 and the function chamber 12 are separated by a retention strip 15 and the valve 13 controls communication or isolation between the food receiving chamber 11 and the function chamber 12. The function chamber 12 may be additionally provided therein with a desiccant 14.

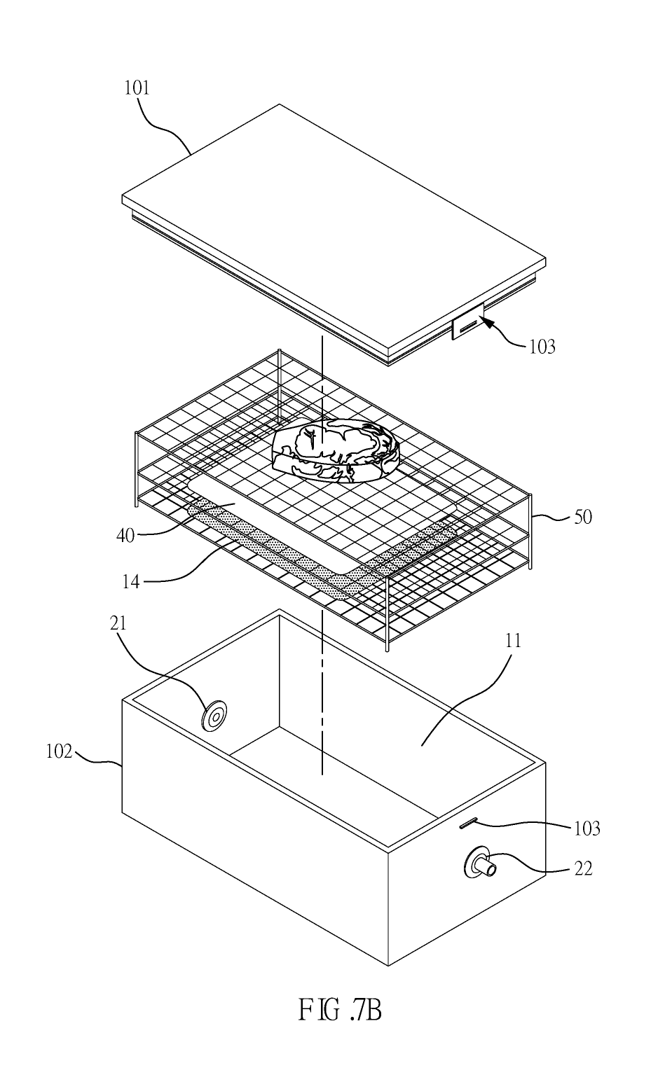

Referring to FIG. 7A, a schematic view showing a sixth example of the food aging device according to the present invention is provided. In the instant example, the main body 10 is made in the form of a box, which is made of a material comprising glass or acrylic that allows for cleaning and washing and is temperature resistant. The main body 10 comprises a top cover 101 and a container 102. The container 102 comprises the food receiving chamber 11 formed therein to allow a user (such as restaurants of steaks and hot pots) to place food to be aged therein. The top cover 101 is set on and covers the container 102 to close an opening of the container 102. The outlet valve 21 and the inlet valve 22 can be provided on the top cover 101 or the container 102.

The use places the food in the container 102 and closes the top cover 101 and then, a food packaging machine (not shown) is applied to evacuate air from the food receiving chamber 11 to set the interior of the food receiving chamber 11 in a vacuum condition. Then, an external gas container (not shown) is used to charge a filling gas into the food receiving chamber 11 to allow the food to contact with the filling gas and thus undergo aging. After the aging process of the food is done, the top cover 101 and the container 102 may then be washed and cleaned and subsequently placed into a drying unit for sterilization in order to allow the food aging device of the present invention to be re-usable for environmental protection purposes. Timing for evacuation or charging the filling gas is variable according to the nature of the food used.

Further, the top cover 101 is provided with a seal strip (not shown) on a flange thereof that correspond to the opening of the container 102 in order to provide a sealing effect when the top cover 101 closes the opening of the container 102 thereby preventing gases of inside and outside from entering the food receiving chamber 11 through minute gaps between the top cover 101 and the container 102.

Further, The present invention further comprises a locking unit 103, and locking unit 103 may securely fix the top cover 101 and the container 102 together to enhance the sealing effect between the top cover 101 and the container 102.

Referring to FIG. 7B, a schematic view showing a seventh example of the food aging device according to the present invention is provided. The instant example further comprises at least one net shelf 50, which is arranged inside the food receiving chamber 11. The net shelf 50 is made of food-grade plastics and is preferably made up of a three-tier structure having a top most tier on which food is placed, a middle tier on which the absorbent 40 is placed, and a bottommost tier on which the desiccant 14 is placed.

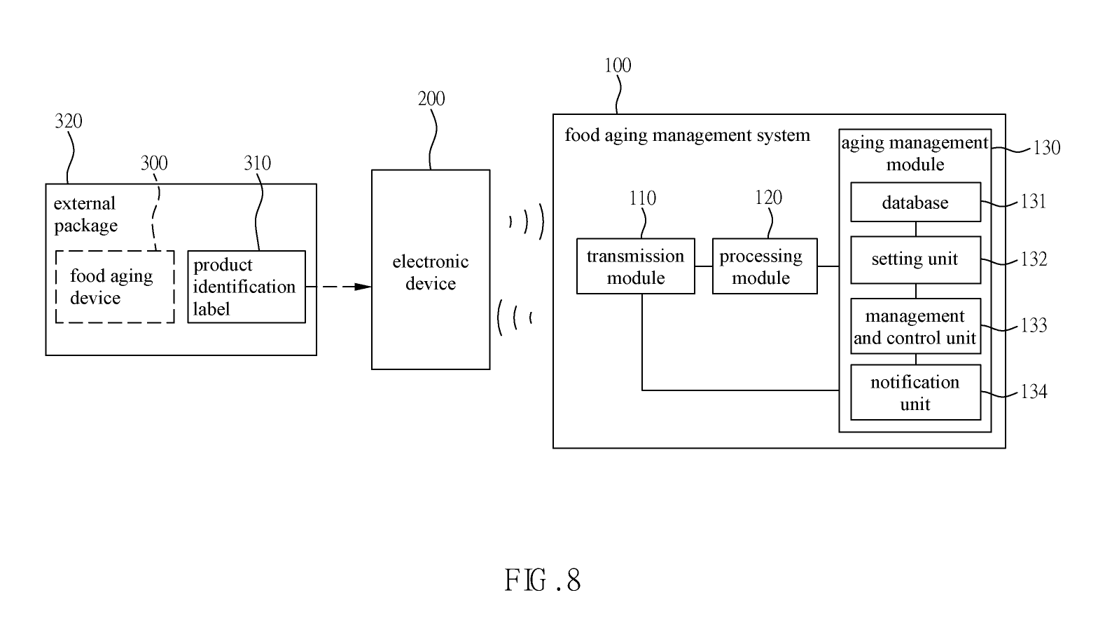

Referring to FIG. 8, an example of architecture of a food aging management system according to the present invention is shown. The present invention provides a food aging management system 100, which comprises a transmission module 110, a processing module 120, and an aging management module 130. The transmission module 110 is operable to detect, by means of an electronic device 200, a product identification label 310 of a food aging device 300 in order to acquire a product signal; the processing module 120 is connected with the transmission module 110 to receive the product signal and to transmit an execution message; and the aging management module 130 is connected with the processing module 120 to receive the execution message to carry out aging management. The aging management module 130 comprises a database 131, a setting unit 132, a management and control unit 133, and a notification unit 134. The database 131 is loaded with and stores aging information; the setting unit 132 provides, according to the aging information, at least one option of aging process and to receive, through a setting interface, a selection message from a user to then transmit a setting message; the management and control unit 133 receives the setting message and manages and controls aging time of the food according to the option of aging process selected by the user and transmits an aging message; and the notification unit 134 receiving the aging message and transmits, through the transmission module 110, a notification message to be displayed on the electronic device 200.

The product identification label 310 of the food aging device 300 may comprise a near field communication (NFC) detection chip or radio frequency identification (RFID) chip, wherein the chip is loaded or stores therein food information of the food 300 or a website of the system to allow the user to directly sense and acquire information with the electronic device 200.

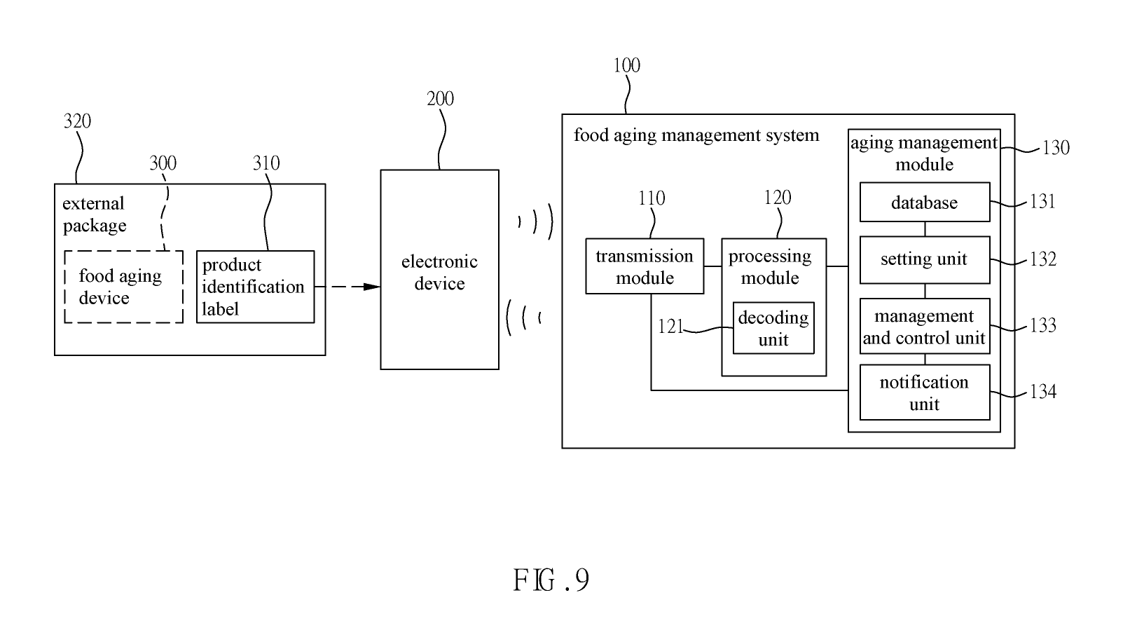

Alternatively, the product identification label 310 of the food aging device 300 may comprises a barcode, such as a two-dimensional barcode (for example QR code), which is encoded from food information of the food to be aged in the food aging device 300, wherein the food information comprises sequential number, production location, shipping location and/or shipping time, and is provided on the food aging device 300 or an external package 320 so that the user may use the electronic device 200 (such as mobile device) to detect and read, through a camera thereof, the barcode to acquire a barcode image, namely the product signal. The processing module 120 of the food aging management system 100 further comprises a decoding unit 121, as shown in FIG. 9, which analyzes the product signal to acquire the food information.

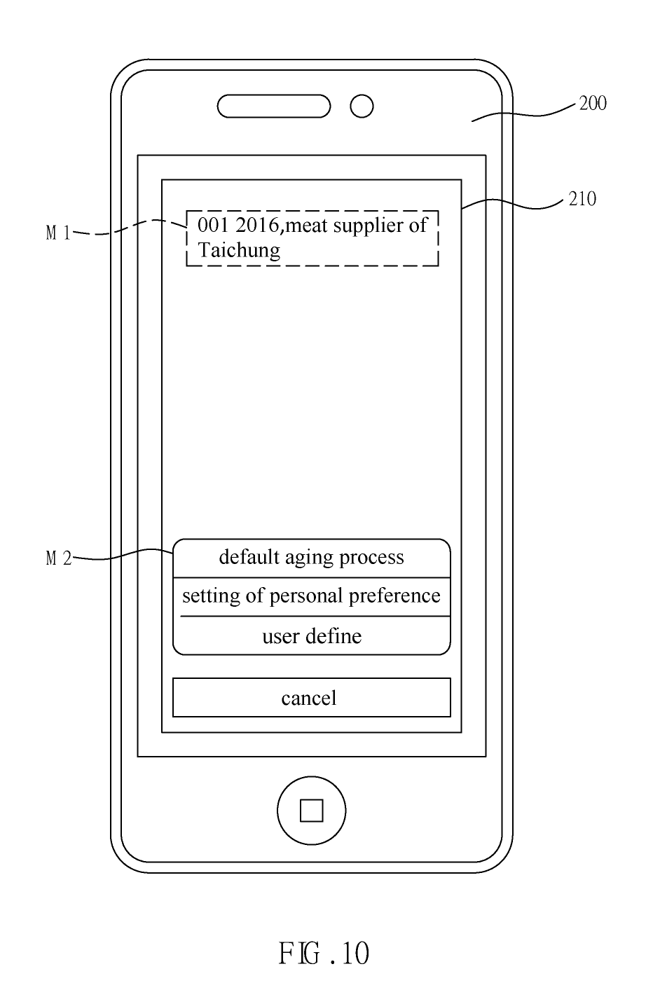

As an additional example, reference being had to FIG. 10, the user first downloads the food aging management system 100 of the present invention in the electronic device 200, such as a mobile phone or a tablet computer. When the user activates the program of the food aging management system 100, the program automatically activate automatic activation of the camera of the electronic device 200 to allow a user to directly detect and read the product identification label 310, such as a QR code, to acquire the product signal, such as a barcode image. The decoding unit 121 of the processing module 120 conducts analysis on the barcode image to retrieve the food information M1 contained in the barcode image.

Next, the processing module 120 transmits the execution message to the aging management module 130 to carry out aging management. The setting unit 132 presents, according to the aging information of the database 131, at least one option of aging process M2 in the setting interface 210 of the electronic device 200 of the user, as shown in FIG. 10, wherein the option of aging process M2 comprises a preset or default option of aging process, option of personal preference, and/or a use-defined option. The contents of the option of aging process is formed according to the aging information, and the aging information comprises storage environment, portions of food, nature of food, and/or aging time. Illustration will be provided below:

The preset option of aging process is an experience value that is formed by collecting experiences of a number of professional persons by means of statistics and may provide suggestions for aging for property of food to be directly selected by the use for carrying out management and control of the aging time. In other words, when the user selects the preset option of aging process, timing management and control will be carried out for the aging time generated according to the preset aging information.

The personal preference option allows for storage of setting values made by the user to allow the user not necessarily to repeatedly make the setting at each time of use.

The user-defined option allows the user to make settings for the aging information for each aging operation (including storage environment, portions of food, and/or nature of food). Taking beef as an example, the storage environment includes freezing, cold storage, or room temperature and the likes; the portions of food include for example brisket, plate, and shank, and the likes; nature of food include grass-fed beef and corn-fed beef. Timing management and control is made for the aging time generated according to the conditions so set.

After completion of setting as described above, the system carries out management and control of the aging time according to the selected option of aging process and display a time axis of the aging time to allow the user to timely control the aging state. After the completion of food aging, the system generates and transmits the notification message to be displayed on the electronic device 200. The notification message comprises pushed texts or ringing sound to remind the user of the completion of aging; or the best taste date is recorded and displayed in a calendar of the electronic device 200 to allow the user to estimate, through reading the calendar of the mobile phone, when the aging of food can be completed.

In addition, the illustration provided above is for the first time that the user makes settings for food aging. Once the settings for food aging has been done once by the user, a second time of detecting and reading the product identification label of the same food with the electronic device, the system will directly display the current aging condition of the food.

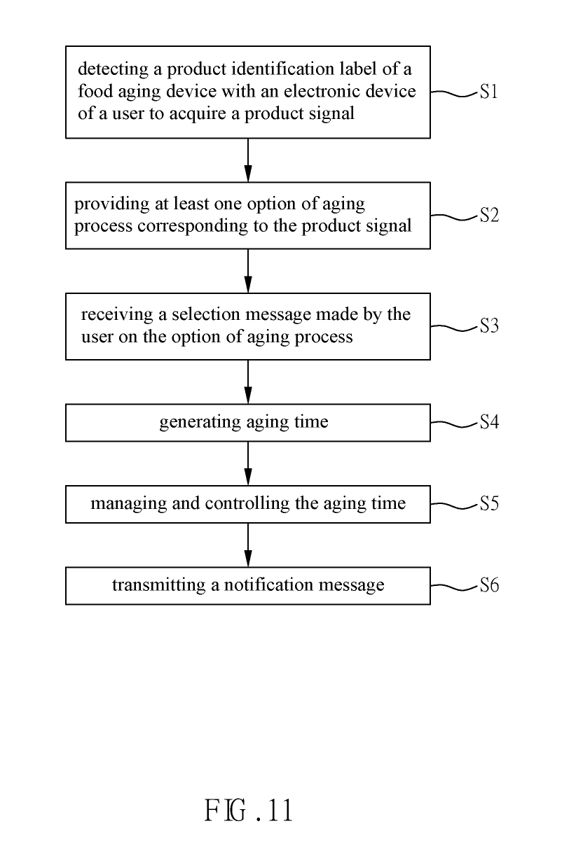

Referring to FIG. 11, a flow chart of a aging management method according to the present invention is shown. The present invention provides a food aging management method, which comprises: detecting a product identification label of a food aging device with an electronic device of a user to acquire a product signal, Step S1; providing at least one option of aging process corresponding to the product signal, Step S2; receiving a selection message of the option of aging process made by a user, Step S3; generating aging time, Step S4; managing and controlling the aging time, Step S5; and transmitting a notification message, Step S6.

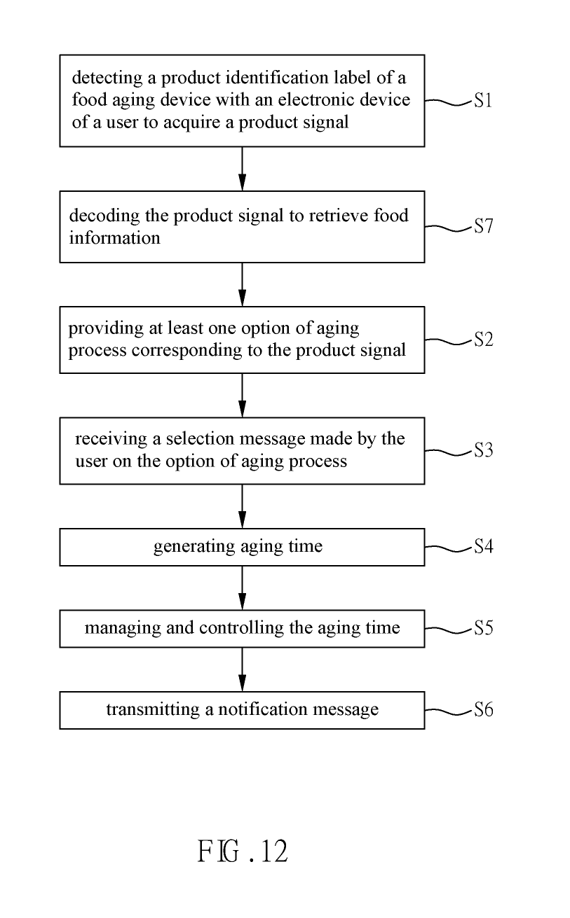

Further referring to FIG. 12, a flow chart illustrating a food aging management method according to another example of the present invention is shown. The instant example further comprises decoding the product signal to acquire food information, Step S7.

The food aging management system can be built up in a cloud server. In other words, the system can be an application program (App) to allow a user to download in an electronic device for use.

the option of aging process comprises a preset or default option of aging process, option of personal preference, and/or a use-defined option. The content of the option of aging process is formed according to the aging information, and the aging information comprises storage environment, portions of food, and/or nature of food. Details are similar to those described with reference to the system of the previous example and repeated description will be omitted.

In addition, the way of transmitting the notification message of Step S6 may comprise transmission made at the time when the aging time is reached, or displaying is made on the calendar of the electronic device after the user selects the option of aging process.

In summary, the present invention provides a food aging device that is useful and convenient and makes the flavor of food similar to that of food that is aged with a traditional dry aging process. Further, the present invention also provides a food aging system and a method thereof, which involve systematic food aging management that allows the user to timely handle the aging state of food and also provides notification at the time when the best taste date of the food is reached, and also provides the user with traceability data of the food, allowing the user to realize information concerning the source, shipping location, or shipping date of the food. Further, the system of the present invention is loaded with suggestions concerning aging processes of various food to be selected and used by non-professional users.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A food aging device, comprising:
a main body, which comprises a food receiving chamber adapted to receive food to be placed therein; and
at least one gas valve, which is mounted to the main body;
wherein gas contained in the food receiving chamber is selectively evacuated through the at least one gas valve or a filling gas is selectively charged into the food receiving chamber.

2. The food aging device according to claim 1, wherein the main body further comprises a function chamber, the function chamber being selectively connected to or isolated from the food receiving chamber through a valve.

3. The food aging device according to claim 2 further comprising at least one desiccant, which is arranged in the function chamber.

4. The food aging device according to claim 2, wherein the valve comprises an inner valve cylinder and an outer valve barrel, the inner valve cylinder being arranged inside the outer valve barrel, the inner valve cylinder being formed with a first air hole, the outer valve barrel being formed with a second air hole, the outer valve barrel having an external wall having an end connected to the food receiving chamber, an opposite end of the external wall of the outer valve barrel being connected to the function chamber.

5. The food aging device according to claim 4, wherein the inner valve cylinder is movable relative to the outer valve barrel such that the first air hole is set in alignment with the second air hole to have the food receiving chamber and the function chamber communicating with each other.

6. The food aging device according to claim 5, wherein the inner valve cylinder has an external wall that is formed with an internal thread, and the outer valve barrel has an internal wall that is formed with an external thread engageable with the internal thread, the inner valve cylinder being turnable with respect to the outer valve barrel.

7. The food aging device according to claim 6, wherein the external wall of the inner valve cylinder is formed with a bump, and internal wall of the outer valve is formed with a cavity that mates the bump so that when the valve is open, the cavity and the bump are in retaining engagement with each other.

8. The food aging device according to claim 2 further comprising at least one assistive chamber and at least one assistive gas valve, the at least one assistive gas valve being structured to communicate with the food receiving chamber and the at least one assistive chamber or to isolate the food receiving chamber and the at least one assistive chamber, the at least one assistive chamber being filled with a gas that is different from the filling gas.

9. The food aging device according to claim 1, wherein the at least one gas valve comprises at least two valves, which are respectively an outlet valve and an inlet valve, the outlet valve being operable to allow the gas contained in the food receiving chamber to be evacuated to form a vacuum condition, the inlet valve being operable to introduce the filling gas into the food receiving chamber.

10. The food aging device according to claim 1 further comprising a carrying tray, which is arranged in the food receiving chamber, the carrying tray having a surface formed with at least one projection, the food being positionable on the surface of the carrying tray that comprises the projection

11. The food aging device according to claim 10 further comprising an absorbent, which is arranged on at least one of a top surface and a bottom surface of the carrying tray to absorb and thus remove liquid or moisture escaping from the food.

12. The food aging device according to claim 1, wherein the main body comprises a pouch.

13. The food aging device according to claim 1, wherein the main body comprises a box, which comprises a top cover, a container, and a locking unit, such that the locking unit is operable to fix the top cover and the container together, the box being made of a material comprises glass or acrylic.

14. The food aging device according to claim 13 further comprising at least one net shelf, which is mounted in the food receiving chamber.

15. A food aging management system, comprising:
a transmission module, which is operable to detect, through an electronic device, a product identification label of a food aging device to acquire a product signal;
a processing module, which is connected to the transmission module to receive the product signal and transmit an execution message; and
an aging management module, which is connected to the processing module to receive the execution message to carry out aging management and comprises:
a database, which is loaded therein with aging information;
a setting unit, which provides, according to the aging information, at least one option of aging process, so as to transmit a setting message upon receiving a message of selection from a user through a setting interface;
a management and control unit, which receives the setting message and conducts an operation of management and control of aging time of food placed in the food aging device according to content of the option of aging process, and transmits an aging message; and
a notification unit, which receives the aging message and transmits, through the transmission module, a notification message to be displayed on the electronic device.

16. The food aging management system according to claim 15, wherein the product identification label comprises a barcode and the product signal comprises a barcode image, the electronic device being operable to detect and read, through a camera, the barcode to acquire the barcode image.

17. The food aging management system according to claim 16, wherein the barcode comprises a two-dimensional barcode, which is formed by encoding food information of the food and is provided on the food aging device or an external package of the food aging device.

18. The food aging management system according to claim 17, wherein the processing module comprises a decoding unit, which is operable to analyze the product signal to acquire the food information.

19. The food aging management system according to claim 17, wherein the food information comprises sequential number, production location, shipping location and/or shipping time.

20. The food aging management system according to claim 15, wherein the option of aging process comprises a default option of aging process, an option of personal preference, and/or a user-defined option.

21. The food aging management system according to claim 15, wherein the aging information comprises storage environment, portion of food, nature of food, and/or aging time.

22. The food aging management system according to claim 15, wherein the notification message comprises displayed texts, ringing sound, or displaying made on a calendar of the electronic device.

23. The food aging management system according to claim 15, wherein the product identification label comprises a near field communication (NFC) detection chip or a radio frequency identification (RFID) chip.

24. A food aging management method, comprising:
detecting a product identification label of a food aging device with an electronic device of a user to acquire a product signal;
providing at least one option of aging process corresponding to the product signal;
receiving a selection message made by the user on the option of aging process;
generating aging time;
managing and controlling the aging time; and
transmitting a notification message.

25. The food aging management method according to claim 24 comprising a step of decoding the product signal to retrieve food information.

26. The food aging management method according to claim 24, wherein the option of aging process comprises a default option of aging process, an option of personal preference, and/or a user-defined option.

27. The food aging management method according to claim 24, wherein content of the option of aging process is generated according to aging information, the aging information comprising storage environment, portion of food, nature of food, and/or aging time.

28. The food aging management method according to claim 24, wherein the notification message is transmitted when the aging time is reached.

29. The food aging management method according to claim 24, wherein the notification message is displayed in a calendar of the electronic device after the user selects the option of aging process.
